(19) United States
(12) Patent Application Publication
(10) Pub. No.: US 2025/0092489 A1
(43) Pub. Date: Mar. 20, 2025

(54) CAPILLARY ELECTROPHORESIS ANALYSIS OF LITHIUM IN BRINE

(71) Applicant: Schlumberger Technology Corporation, Sugar Land, TX (US)

(72) Inventors: Sharath Chandra Mahavadi, Cambridge, MA (US); Dominic Vincent Perroni, Sugar Land, TX (US); Ling Feng, Cambridge, MA (US); Rod William Shampine, Sugar Land, TX (US); Ankur D. Jariwala, Katy, TX (US)

(21) Appl. No.: 18/293,525

(22) PCT Filed: Aug. 1, 2022
(86) PCT No.: PCT/US2022/039021

§ 371 Date: Jan. 30, 2024

Related U.S. Application Data
(60) Provisional application No. 63/203,774, filed on Jul. 30, 2021.

(51) Int. Cl. C22B 26/12; C22B 3/42; C25B 7/00

(52) U.S. Cl. CPC C22B 26/12; C22B 3/42; C25B 7/00

(57) ABSTRACT

Capillary electrophoresis is used to monitor concentration of components in streams of a lithium recovery process.

### CROSS-REFERENCE TO RELATED APPLICATIONS

This patent application claims benefit of U.S. Provisional Patent Application Ser. No. 63/203,774 filed Jul. 30, 2021, which is entirely incorporated herein by reference.

### FIELD

This patent application describes methods and apparatus for lithium recovery from aqueous sources. Specifically, processes for on-line, at-line, and offline analysis of lithium in brine streams for use in lithium recovery is described.

### BACKGROUND

Lithium is a key element in energy storage. Electrical storage devices, such as batteries, supercapacitors, and other devices commonly use lithium to mediate the storage and release of chemical potential energy as electrical current. As demand for renewable, but non-transportable, energy sources such as solar and wind energy grows, demand for technologies to store energy generated using such sources also grows.

According to the United States Geological Survey, global reserves of lithium total 21 million tons (metric) of lithium content, with Chile, Australia, Argentina, and China accounting for about 82% of global reserves. U.S. Geological Survey, Mineral Commodity Summaries, January 2021. Global production of lithium content was 82 kT in 2020 and 86 KT in 2019. Global consumption was estimated at 56 kT in both 2019 and 2020. Id. By one estimate, global lithium demand is expected to reach 1.79 MTa of lithium carbonate equivalent, which is approximately 339 kTa of lithium content, by 2030 for an average annual growth in demand of approximately 22%. Supply is currently forecast to run behind demand, with lithium prices expected to triple by 2025, by some estimates. The incentive for more lithium production could not be clearer.

The mining industry has numerous techniques for the extraction of lithium from mineral or saline waters. Hard rock mining with acid digestion is common, but labor intensive. Methods currently used for salar lakes involve evaporation ponds with chemical additives to selectively precipitate the lithium. This process requires months to complete yielding a material containing roughly 50-60% lithium.

In recent years, companies are investigating improved methods to recover lithium directly from salar lakes that avoid evaporation, are faster and have high lithium yield. Many techniques use adsorbents that selectively recover lithium, followed by a wash step that liberates the lithium for further processing. Solid and liquid adsorbents are used. These adsorbents can be very sensitive to impurities such as divalent ions, silica, and metals.

The methods above are generally difficult to scale, are expensive to operate, and are generally not efficient and environmentally benign in use of water. New apparatus and methods of lithium extraction are needed. On-line methods to monitor lithium content of brine streams in lithium recovery processes are also needed.

### SUMMARY

Embodiments described herein provide a method of recovering lithium from a lithium source, comprising withdrawing lithium from the lithium source using an ion withdrawal stage to form an eluate and a lithium-depleted stream; and monitoring concentration of one or more components in any or all of the lithium source, the eluate, and the lithium-depleted stream using a capillary electrophoresis instrument.

Other embodiments described herein provide a method of recovering lithium from a lithium source, comprising extracting lithium from the lithium source using an absorption/desorption process to form a lithium extract; processing the lithium extract using a concentrator to form a lithium concentrate; recycling a process stream from the concentrator to the absorption/desorption process; and monitoring lithium concentration in the lithium concentrate, the process stream, or both using a capillary electrophoresis instrument.

Other embodiments described herein provide method of recovering lithium from a lithium source, comprising performing a plurality of sequential transformations, each transformation converting an input derived from the lithium source into an output containing lithium and a byproduct, the sequential transformations including an ion withdrawal process; and monitoring a concentration of one or more components in one or more inputs, outputs, or byproducts using a capillary electrophoresis instrument.

### BRIEF DESCRIPTION OF THE DRAWINGS

FIG. 1 is a schematic side view of a lithium process that uses a lithium analyzer for analyzing lithium content of a brine stream according to one embodiment.

FIG. 2 is a process diagram of a lithium extraction process according to one embodiment.

FIG. 3 is a process diagram of a lithium recovery process according to one embodiment.

### DETAILED DESCRIPTION

Capillary electrophoresis (“CE”) is used to detect and monitor lithium concentration and/or concentration of other components in streams of lithium recovery processes. The technique is useful for analysis of lithium in brine streams found in lithium extraction processes. Such processes may use lithium-selective absorbents to absorb lithium from a brine stream and then release the lithium into an aqueous stream of controlled composition to yield a lithium containing stream from which lithium can be recovered. Other recovery processes can also be used, and other components, which can be ions or uncharged components, can be analyzed using CE. Techniques of CE are generally useful for composition analysis and control in lithium recovery processes of all kinds.

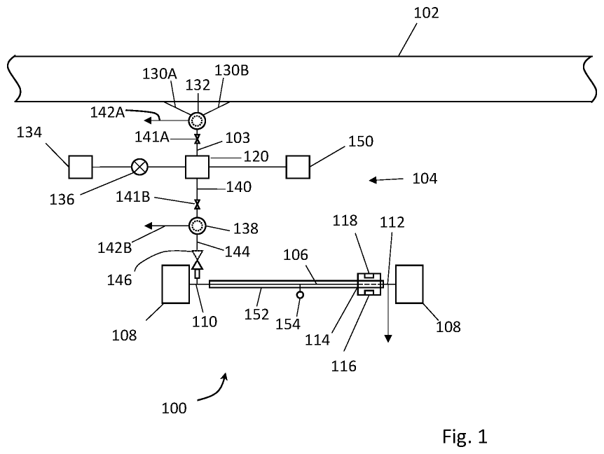

FIG. 1 is a schematic diagram of a lithium process using an in-line CE analyzer 100 for a lithium-containing stream. The stream is generally depicted flowing in a pipe 102, with the analyzer 100 coupled to the pipe by a sampling system 104. The sampling system 104 is depicted as obtaining samples from two sampling locations 130A and 130B. One sampling location, or more than two sampling locations, can be used with one analyzer 100. A selection valve 132 is operable to draw samples selectively from either sampling location 130A or 130B. A sample line 103 brings material from the selection valve 132 to a sample chamber 120, which stages the sample for analysis. A solvent source 134 is coupled to the sample chamber 120 by a pump 136 so that solvent can be provided to the sample chamber 120 to dilute the sample, if desired. The solvent can also be used to flush the sample chamber 120 between samples. A second selection valve 138 is coupled to an outlet 140 of the sample chamber 120. Flush material can be routed from the solvent source 134 to the sample chamber 120, and then to the first selection valve 132 for disposal along a first flush line 142A. Alternately, flush material can be routed from the solvent source 134 to the sample chamber 120, and then to the second selection valve 138 for disposal along a second flush line 142B or to an analyzer feed line 144. A first block valve 141A can be operated to route the flush material along the first flush line 142A, and a second block valve 141B can be operated to route the flush material along the second flush line 142B. The sampling system 104 can thus have zero, one, two, or more flush lines. A sample fitting 146 may be coupled to the analyzer feed line 144 to allow for disconnecting the analyzer 100 from the sampling system 104, in the event a portable analyzer 100 is used. Note that other valves, tubes, and/or pipes that may be appropriate for flowing samples to and from the analyzer 100 are omitted for simplicity of explanation.

The analyzer 100 generally has a capillary tube 106 juxtaposed with an electric field source 108 that when energized creates an electric field oriented along an axis of the capillary tube 106. The electric field source 108 comprises a cathode and an anode positioned at either end of the capillary tube 106. In most cases, the cathode and anode are immersed in fluid to propagate the electric field through the fluid. A power supply (not shown) powers the electric field source 108. The capillary tube 106 has an entrance end 110 and an exit end 112. A detector cell 114 is coupled to the capillary tube 106, and may be located at, near, or adjacent to the exit end 112. The detector cell 114 applies probe energy to the fluid in the capillary tube 106 to produce a signal representing the composition of the fluid in the capillary tube 106. The detector cell 114 may be a UV transmission cell, an electrical conductivity cell, a mass spectrometry cell, or other suitable detector type. The detector cell 114 generally comprises an energy source 116 and a detector 118 oriented to couple the probe energy into the fluid within the capillary tube 106 and to detect energy emerging from the capillary tube 106 following interaction with the fluid therein. Effect of the fluid on the energy is resolved by the detector 118 as a signal, or a plurality of signals, such as a spectrum or an intensity of one wavelength or a small collection of wavelengths, that relates to the composition of the fluid.

In one embodiment, the energy source 116 is an ultraviolet light (UV) source and the detector 118 is a UV detector. The UV source may use a single wavelength or multiple wavelengths. In some cases, a broadband UV source may be used, and the detector 118 may be a spectrometer to resolve transmission of different wavelengths. A usable capillary electrophoresis instrument is commercially available from multiple suppliers. UV wavelengths such as 200 nm and 214 nm are usable. In other embodiments, the energy source may be an electric current source and the detector may be a conductivity detector. In still other embodiments, the energy source may be a magnet to deflect ions moving through the magnetic field of the magnet toward an ion detector, similar to a mass spectrometer. The ion detector can differentiate ions by migration time or detection location.

The sampling system 104 has a sample chamber 120 that holds a fluid to be routed to the capillary tube 106. The sample chamber 120 collects a sample of a prescribed size for flowing through the capillary tube 106. The sample is hydrodynamically injected into the capillary tube 106 from the sample chamber 120, either by applying positive pressure or vacuum to the sample chamber 120, while electric field is applied by the source 108. Here, a pressure source 150 is fluidly coupled to the sample chamber 120 to provide pressure to hydrodynamically inject the sample from the sample chamber 120 into the capillary tube 106. The pressure source 150 can provide a pressurized gas into the sample chamber 120 to hydrodynamically inject the sample from the sample chamber 120 into the capillary tube 106 without altering the liquid composition of the sample. The sample can also be electrokinetically injected into the capillary tube 106 by fluidly connecting the sample chamber 120 to the capillary tube 106, coupling electrodes to the sample chamber 120 to provide an electric field within the sample chamber 120, and maintaining neutral hydrodynamic pressure from the sample chamber 120 through the capillary tube 106. The pressure source 150 can be configured to maintain neutral pressure in the sample chamber 120 during the injection process. The electric field acts to affect the rate at which species in the sample arrive at the detector 114. The detector 114 records a time-series of transmission intensity, while the sample flows through the capillary tube 106, which can be related to composition of the sample.

The analyzer 100 is can be operated under isothermal conditions by controlling temperature within the capillary tube 106. A thermal control member 152 can be coupled to the capillary tube 106 to control temperature within the capillary tube 106. The thermal control member 152 can be a fluid jacket or resistive heat jacket, or both, for raising or lowering a temperature of the fluid flowing through the capillary tube 106 in order to control the temperature of the fluid. A fluid jacket can use a liquid or gas as a thermal control medium to exchange thermal energy with the fluid flowing through the capillary tube 106 to heat or cool the fluid flowing through the capillary tube 106 to control the temperature of the fluid flowing through the capillary tube 106 to maintain isothermal operating conditions for the analyzer 100. One or more temperature sensors 154 can be coupled to the capillary tube 106 for sensing the temperature of the fluid flowing through the capillary tube 106. The thermal control member 154 can be operated based on readings from the one or more temperature sensors 152 to maintain isothermal conditions for operation of the analyzer 100. The analyzer 100, with sampling system 104, is an example of a CE system that can be used to detect, monitor, and control composition of material flowing through the pipe 102. Any type of CE system can be used in a lithium recovery process to detect, monitor, and control composition of streams therein.

The sampling system 104 is configured, in this case, to operate substantially independently from the analyzer 100. The sampling system 104 is configured to automatically collect and prepare a sample for analysis by the analyzer 100 without impacting operation of the analyzer 100. To prepare a sample for analysis, a controller (not shown), or a human operator, can open valve 141A to allow flow of fluid from the pipe 102 to the sample chamber 120 through the sample line 103. The selection valve 132 can be set to allow flow from one or both the sampling locations 130A and 130B to the sample chamber 120. Solvent can be routed to the sample chamber 120 from the solvent source 134. One or both of the valve 141B and the valve associated with the sample fitting 146 can be kept closed to isolate the sampling system 104 from the analyzer 100 while the sample is being prepared. The pressure source 150, or other means, can be used to maintain a target pressure in the sample chamber 120 while fluids are flowed into the sample chamber 120. In an alternate method, a sample can be prepared in the sample chamber 120 by simultaneously flowing fluid from the pipe 102 through the sample chamber 120 to the second selection valve 138 and into the second flush line 142B and flowing solvent from the solvent source 134 through the sample chamber 120 to the second selection vavle 138 and the second flush line 142B. When a steady flow state is established through the sample chamber 120, valve 141B can be closed to stop flow and valve 141A can then be closed to isolate the sample. When the analyzer 100 is prepared to accept the sample, the second selection valve 138 can be set to flow from the sample chamber 120 to the analyzer 100, the valve 141B can be opened, and the pressure source 150 can be used to inject the sample from the sample chamber 120 to the analyzer 100 through the analyzer feed line 144.

The analyzer 100 can be calibrated for analyzing lithium in aqueous streams in three general ways. First, a known solution of a lithium salt, such as lithium chloride, can be used as a calibrant. A known amount of lithium salt is dissolved in deionized water to yield a solution of known lithium concentration. Standard solutions can also be obtained from vendors of such materials. When this solution is measured using the analyzer 100, the resulting signature can be related to the known lithium concentration. Multiple such calibrants having different lithium concentrations can be analyzed to develop a calibration curve. Second, a known mixture of electrolytes including lithium can be prepared and analyzed. For example, a known quantity of a salt containing lithium, for example lithium chloride, along with known quantities of calcium, magnesium, sodium, which may be chlorides and/or other anions, can be added to deionized water to prepare calibrants for analysis. In this way, a multivariate calibration curve can be constructed. Most modern instruments have software or firmware for calibration of this type. A third way of calibrating the instrument is to obtain wild brine samples from a natural source, analyze them using well-characterized procedures to determine a high-confidence composition of the natural source, and then analyze them using the analyzer 100. Hybrid methods can be used also, for example a natural brine sample that is adjusted in some way to optimize the calibration. In these ways, the results of the analyzer 100 can be related to another well-known analytical technique.

In lithium recovery operations using brine sources, lithium concentration can be measured at a number of locations in the process having very different lithium concentration. The concentration can range from 100 ppm, or below, in the brine source up to the solubility limit of lithium salts, for example as much as 123 g/mL in some process streams. Lithium compositions down to zero ppm can be detected and monitored in some streams of a lithium recovery process. Calibration data can be generated in the vicinity of concentrations to be measured using the analyzer 100 to improve accuracy. Accuracy of the instrument at target concentration ranges can be tested using known solutions. For example, if lithium concentrations in a stream are expected to be in the range of 500 ppm, the CE analyzer can be calibrated using samples of known concentration in a range around 500 ppm to generate a calibration curve for the analyzer. A CE analyzer for measuring lithium concentration in an aqueous stream can be calibrated across a wide range of lithium concentrations using suitable calibrants so a single analyzer can be used for multiple streams of a lithium recovery process.

To facilitate measurement across a broad range of lithium concentrations, analysis parameters, such as electric field strength, sample dilution, energy source parameters, detector parameters, and capillary dimensions, can be changed to optimize instrument sensitivity. For example, at very high lithium concentrations, an instrument optimized and calibrated for mid-range or low-range concentrations can reach a saturation level where transmitted energy intensity is so low that the detector loses accuracy. In such cases, capillary diameter can be reduced to provide more transmitted photons and/or electric field strength can be increased to provide more differentiation of charged species in the solution. High-concentration samples can also be diluted. Such procedures must be subjected to calibration to resolve usable data. Individual instruments can be used to separately analyze high-concentration and low-concentration solutions to avoid saturating an instrument. Alternately, a single instrument can be used with different test procedures for high-concentration and low-concentration samples.

In some cases, a single instrument might be used to analyze multiple transmitted wavelengths to define signatures usable to determine lithium content. For example, a ratio of transmitted intensity at two wavelengths may, in some cases, provide increased sensitivity. The optimum test procedure and instrument configuration and calibration for a particular brine stream can be determined through routine testing of a known representative of the brine stream.

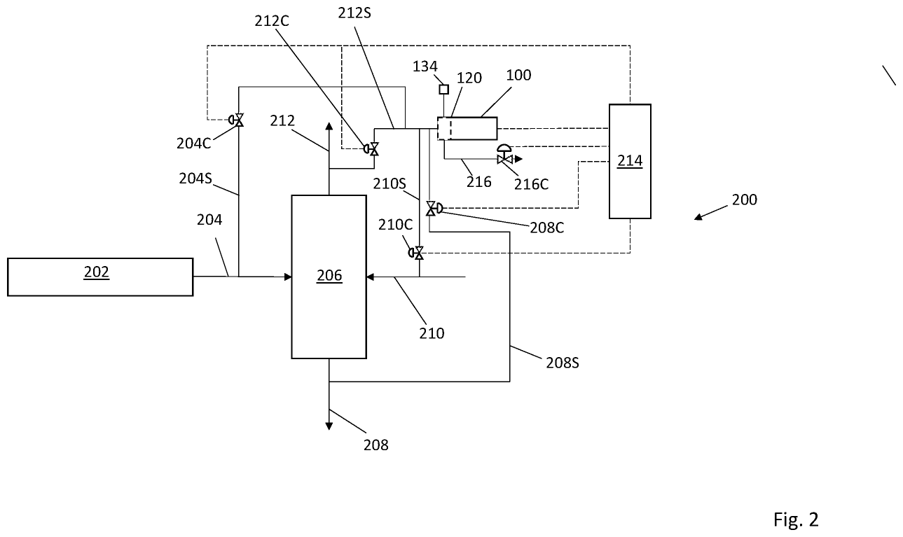

FIG. 2 is a process diagram of a lithium recovery process 200, according to one embodiment. The lithium recovery process 200 employs on-line lithium analyzers of the type described herein to monitor lithium concentrations throughout the process. In this case, the lithium recovery process 200 uses an extraction process, which may be a sorption/desorption process, to extract lithium from a lithium source 202. A brine 204 obtained from, or derived from, the lithium source 202 is provided to an ion withdrawal stage 206 that withdraws lithium from a lithium containing stream. The sorption medium may be liquid or solid. In the liquid case, the liquid sorption medium contacts the brine 204, absorbing lithium from the brine 204 and yielding a lithium-depleted brine 208. In the solid case, the brine 204 contacts the solid sorption medium, which adsorbs or absorbs lithium from the brine 204. An eluate 210 is contacted with the loaded sorption medium, either in the ion withdrawal stage 206 as shown in FIG. 2 or using a different vessel, to remove lithium from the sorption medium into the eluate to yield a lithium extract 212.

The in-line lithium analyzer 100 is coupled to the various streams surrounding the ion withdrawal stage 206 to provide signals representing lithium concentration to a controller 214. In this case, one analyzer 100 is used, and four streams are separately connected to the analyzer 100 using a sampling system similar to the sampling system 104. A brine sample stream 204S of the brine 204 is routed to the analyzer 100. The brine sample stream 204S includes a flow control device 204C to control flow of fluid from the brine stream 204 to the analyzer 100. An extract sample stream 212S of the lithium extract 212 is routed to the analyzer 100, and includes a flow control device 212C. An eluate sample stream 210S is routed to the analyzer 100, and includes a flow control device 210C. A depleted brine sample stream 208S is routed to the analyzer 100, and includes a flow control device 208C. The sample streams 204S, 208S, 210S, and 212S are separately routed to the analyzer 100, but may join in a manifold (not shown) at an entry of the analyzer 100.

The sample streams 204S, 208S, 210S, and 212S provide samples from different locations in the process that may have very different compositions. The sample streams are provided to the sample chamber 120 for flowing into the capillary tube 106. A flush line 216 may be provided to remove material from the sample chamber 120. The flush line 216 provides the capability to flow material from one of the sample streams 204S, 208S, 210S, and 212S through the sample chamber 120 to the flush line 216 to ensure material captured in the sample chamber 120 is representative of the material to be sampled and analyzed by the analyzer. A solvent source 134 can be used to provide material to the sample chamber 120 for flush or dilution, as in FIG. 1, and the flow control and two-direction flush equipment of the sampling system 104 of FIG. 1 can also be included in FIG. 2. In this way, one analyzer 100 can be used for multiple streams, and any potential cross-contamination can be minimized. A flush flow control device 216C controls flow through the flush line 216.

The controller 214 is coupled to the analyzer 100 and to the flow controllers 204C, 208C, 210C, 212C, and 216C to administer sampling and analysis of the sample streams 204S, 208S, 210S, and 212S. To sample a stream, the controller 214 opens the flush flow control device 216C and one of the stream flow control devices, for example the brine sample flow control device 204C. Material from the brine 204 flows through the sample stream 204S and through the sample chamber 120 to flush any residual material out of the sample chamber 120. After a designated flush time, which is typically predetermined, the controller 214 closes the flush flow control device 216C to capture a sample aliquot in the sample chamber 120. The controller 214 then closes the sample flow control device, in this case the flow control device 204C. The sample captured in the sample chamber 120 is then flowed through the capillary tube 106 (FIG. 1) and signals representing composition of the sample are sent to the controller 214. The controller 214 compares the signals received to an appropriate calibration or model to determine lithium concentration in the sample.

The controller 214 may be configured to repeatedly sample each stream operatively coupled to the controller 214. Depending on the length of sample lines, sample loop times may differ for the streams. The controller 214 can be configured, using appropriate software, to commence sampling each stream in turn after receiving the signals from the analyzer 100 representing composition of the sample just analyzed. In this way, the analyzer 100 can be operated semi-continuously to provide in-line analysis of lithium concentration in streams interacting with the ion withdrawal stage 206.

It should be noted that streams of the lithium recovery process 200 could be sampled manually and brought to an analyzer like the analyzer 100 for analysis without using an automated system. For example, in one alternate method, samples can be collected manually and transported to the analyzer automatically, using a vial transport system. In another alternative, the samples can be collected manually and brought to the analyzer manually for analysis. In such cases, the samples can be manually or automatically loaded into the sample chamber of the analyzer.

It should also be noted that the sampling system 104 is shown here as a separate component from the analyzer 100, but the sampling system could also be considered part of the analyzer. In other words, a CE analyzer can have a sampling system as a component thereof, or a CE analyzer can be separate and separable from the sampling system. In most cases, a sampling chamber is used to prepare a sample for the capillary of the CE analyzer. The sampling chamber can be considered part of the analyzer or a separate component from the analyzer (i.e. part of the sampling system).

Although not shown in FIG. 2, the various streams sampled in FIG. 2 can also be subject to control by the controller 214. Flow control devices can be used to control flow rates of each stream, and thermal devices can be used to control temperature of each stream, if desired. The controller 214 may be configured to control flow rates and temperatures of streams interacting with the ion withdrawal stage 206 to target, for example, lithium concentration in the lithium extract 212.

It should be noted that the analyzer 100 can be used to monitor concentrations of any number of ionic species susceptible to electrophoresis. For example, impurities such as calcium and magnesium can be analyzed using embodiments of the analyzer 100, appropriately configured and calibrated for the expected concentrations. Thus, the analyzer 100 could be configured to monitor concentrations of impurities such as sodium, calcium, and magnesium in the lithium extract 212 and to adjust operation of impurity removal systems that may be used together with the ion withdrawal stage 206. The analyzer 100 can also be configured to monitor concentrations of impurities in the lithium-depleted brine 208 before returning the lithium-depleted brine 208 to the environment. Capillary electrophoresis has very broad applicability to determination of species in brine streams. For example, concentration of organic impurities, such as scale or corrosion inhibitors commonly found in oilfield water, can be ascertained using a capillary electrophoresis analysis system like that described herein. Such impurities can hamper various separations operations used in treatment and/or operation of hydrocarbon reservoirs, such as membrane and filtration operations. Processing aids for lithium recovery can also be monitored using the analyzers described herein. For example, species arising from impurity removal steps and/or lithium transfer steps, such as sodium, sulfates, and other species, can be monitored using methods and apparatus described herein.

One analyzer 100 is shown being shared amongst four streams in FIG. 2, but more than one analyzer 100 can be used. Use of multiple analyzers 100 can simplify calibration to cover very wide concentration ranges, with the potential, however, for independent instrument inaccuracies that might need to be managed using control techniques. For example, concentrations of species of interest in the lithium-depleted brine 208 might be very low, calling for a dilute configuration and calibration of the analyzer 100, while concentration of species of interest in the lithium extract 212 might be very high, calling for a very different configuration and calibration. Monitoring these streams using different analyzers can simplify the calibration task.

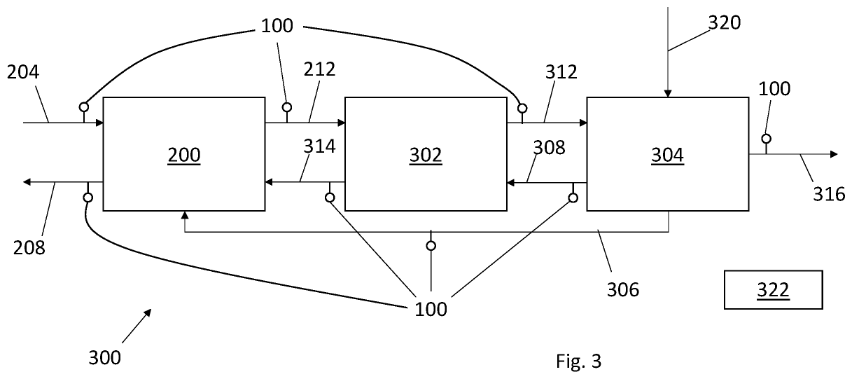

FIG. 3 is a schematic process flow diagram summarizing a lithium recovery process 300 according to one embodiment. In this case, the lithium recovery process 200 is part of the lithium recovery process 300. The lithium extract 212 is provided to a concentrator process 302 that further increases concentration of lithium, producing a lithium concentrate 312. The concentrator process 302 may include membrane processes and filtration processes to remove water, and potentially impurities, from the lithium extract 212. Alternately or additionally, the concentrator process 302 may include evaporation processes that may be thermal and may include reduced pressure operation. The removed water and impurities can be recycled to the lithium recovery process 200 in a concentrator recycle 314. The lithium concentrate 312 is provided to a conversion process 304 to convert the lithium in the lithium concentrate 312 to a product form, which exits as a lithium product 316. In one embodiment, the conversion process 304 uses one or more reagents 320 to convert the lithium. For example, calcium hydroxide can be used in a conversion process that converts lithium chloride to lithium hydroxide. Sodium carbonate can be used to convert lithium chloride to lithium carbonate and calcium hydroxide can be used to convert lithium carbonate to lithium hydroxide. The conversion process 304 can generate recycle that can be used as, or with, eluent or eluate streams, or can be added to feed streams, in the lithium recovery process 200 or in the concentrator process 302, for example as a membrane sweep. For example, a first conversion recycle 308 may be provided to the concentrator process 302, while a second conversion recycle 306 is provided to the lithium recovery process 200 as eluent.

In-line lithium analyzers 100 can be deployed to sample all streams of interest in the lithium recovery process 300. A controller 322 can be operatively coupled to the analyzers 100, and to control equipment of the process 300, to control the process 300 based on signals from the analyzers 100. The controller 322 may directly control all operations of the process 300, including operations of the lithium recovery process 200 (i.e. instead of the controller 214), or the controller 322 may be a supervisory controller operatively coupled to the analyzers 100 and to controllers, such as the controller 214, for the individual processes 200, 302, and 304. Although individual analyzers 100 are shown for the streams of the process 300, a single analyzer 100 can be used to sample multiple streams of the process 300, as in FIG. 2. The controller 322 can be configured to control flow rates throughout the process 300 based on signals from the analyzers 100. In particular, the controller 322 can be configured to adjust flow rates of the recycle streams depending on signals representing lithium content and/or signals representing impurity content. For example, where one or more analyzers 100 indicate increasing impurity content, the controller 322 can be configured to slow overall throughput of the process 300 to increase the effectiveness of impurity removal and direction toward the lithium-depleted brine 208. In general, the controller 322 can be configured to monitor, adjust, and control parameters such as pH, temperature, flow rate, reagent dose and/or flow ratio to dosed stream based on detected ion content of any representative ion in any desired stream using the analyzers 100. The controller 322 can, for example, be coupled to one of the analyzers 100 coupled to a lithium containing stream to monitor lithium concentration of the lithium containing stream. The controller 322 can also, for example, be coupled to one of the analyzers 100 coupled to a lithium depleted stream to monitor effectiveness of lithium removal. The controller 322 can also, for example, be coupled to one of the analyzers coupled to a reaction stream to monitor effectiveness or efficiency of the reaction. For example, where lithium is converted from one form to another, the controller 322 can be coupled to one of the analyzers 100 coupled to the converted stream to monitor quantity of unconverted lithium. The controller 322 can be configured to resolve any or all of the above scenarios using the analyzers 100. The controller 322 can be configured using machine learning techniques to exercise multi-level and multi-variate control over the process 300 to optimize any desired parameter, using the in-line analyzers 100.

Data from a capillary electrophoresis analyzer can be collected, aggregated, transmitted, stored and accessed locally, or remotely, in a processing system coupled to an individual analyzer, for an area where one or more such analyzers are used, for a large installation with multiple analyzer collections, or for a region where multiple large installations may be located. Signal intensity data, as a function of time, received from a capillary electrophoresis analyzer can be automatically processed to identify intensity peaks, associate those peaks with specific ions, select a baseline, start time, and stop time to perform an integration of selected peaks, and determine area of the selected peaks using a calibration relation. Such an algorithm can also be configured to generate concentration curves by comparing computed areas to standard data. The signal processing to resolve peak areas, and ion concentration from the peak areas, can be performed locally at the analyzer using an edge processor, at a central processor local to the analyzer, or to a plurality of analyzers, or remotely. The data can be collectively accessed, analyzed, and processed using standard machine learning and artificial intelligence algorithms to detect patterns and to optimize and control operations at all levels of detail.

The recovery process of FIG. 3 is an example of a lithium recovery process that can be used in cases where lithium sources appropriate for such a process are accessible. Other lithium recovery processes can be used with CE analyzers. Such processes can include ion withdrawal stages along with other stages or processes such as impurity removal and concentration. Lithium processes that can be used can also include evaporation processes and electrochemical processes, all of which can be used with CE analyzers. In general, lithium recovery processes have sequential stages where an input derived from a lithium source is transformed into an output and potentially one or more byproducts. For example, in the ion withdrawal stages described herein, a brine derived from a lithium source is subjected to withdrawal of lithium to form a lithium extract and a lithium-depleted brine. The processes are typically sequential, with the output of one process providing input for another process. For example, in the process of FIG. 3, the lithium extract 212 is a product of the lithium recovery process 200 and an input of the concentration process 302, and the lithium concentrate 302 is a product of the concentration process 302 and an input of the conversion process 304. The concentrator recycle 314 is, likewise, a byproduct of the concentration process 302, and the conversion recycle 308 is a byproduct of the conversion process 304. In any lithium recovery process, any stream used as input, and any output or byproduct of any stage or process may be monitored using a CE instrument to monitor concentration of any species, charged or uncharged. The CE instrument is configured to monitor charged or uncharged species, or both, using calibration and configuration procedures known in the art of capillary electrophoresis analysis. Examples of lithium recovery processes that can be monitored using CE instruments are described in other patent applications by the present Applicant for patent, such as United States Patent Publication No. 2022/0055910 and U.S. Provisional Patent Application Ser. No. 63/364,142, both of which are incorporated herein by reference.

While the foregoing is directed to embodiments of the present invention, other and further embodiments of the present disclosure may be devised without departing from the basic scope thereof, and the scope thereof is determined by the claims that follow.

We claim:

1. A method of recovering lithium from a lithium source, comprising:
withdrawing lithium from the lithium source using an ion withdrawal stage to form an eluate and a lithium-depleted stream; and
monitoring concentration of one or more components in any or all of the lithium source, the eluate, and the lithium-depleted stream using a capillary electrophoresis instrument.

2. The method of claim 1, wherein the one or more components includes lithium.

3. The method of claim 2, wherein the one or more components further includes a non-lithium component.

4. The method of claim 1, wherein the ion withdrawal stage uses a lithium-selective absorbent medium to absorb lithium from the lithium source, and an eluent removes lithium from the absorbent medium to form the eluate.

5. The method of claim 4, wherein the capillary electrophoresis instrument is a first capillary electrophoresis instrument, and further comprising;
converting lithium in the eluate from one form to another in a conversion stage to form a lithium product; and
monitoring concentration of one or more components in the lithium product using a second capillary electrophoresis instrument.

6. The method of claim 1, wherein the monitoring concentration of one or more components in any or all of the lithium source, the eluate, and the lithium-depleted stream using a capillary electrophoresis instrument comprises preparing a sample using an automated sampling system and providing the sample to the capillary electrophoresis instrument using the automated sampling system.

7. The method of claim 1, wherein the capillary electrophoresis instrument is coupled to the lithium source, the eluate, the lithium-depleted stream, or a combination thereof.

8. The method of claim 1, further comprising adjusting an operating parameter of the ion withdrawal stage based on a signal from the capillary electrophoresis instrument.

9. The method of claim 8, wherein the operating parameter is a pH, a temperature, a pressure, a processing time, a cycle time, a flow rate, or a stream split of the ion withdrawal stage.

10. A method of recovering lithium from a lithium source, comprising:
extracting lithium from the lithium source using an absorption/desorption process to form a lithium extract;
processing the lithium extract using a concentrator to form a lithium concentrate;
recycling a process stream from the concentrator to the absorption/desorption process; and
monitoring lithium concentration in the lithium concentrate, the process stream, or both using a capillary electrophoresis instrument.

11. The method of claim 10, wherein the absorption/desorption process forms a lithium-depleted stream, and the capillary electrophoresis instrument is also used to monitor lithium concentration in the lithium-depleted stream, the lithium extract, or both.

12. The method of claim 10, further comprising monitoring concentration of a non-lithium component in the lithium concentrate, the process stream, or both using the capillary electrophoresis instrument.

13. The method of claim 2, wherein the absorption/desorption process forms a lithium-depleted stream, and the capillary electrophoresis instrument is also used to monitor lithium concentration and concentration of a non-lithium component in the lithium-depleted stream, the lithium extract, or both.

14. The method of claim 10, wherein the capillary electrophoresis instrument is a first capillary electrophoresis instrument, and further comprising converting lithium in the lithium concentrate from one form to another using a conversion stage to form a lithium product and monitoring concentration of one or more components in the lithium product using a second capillary electrophoresis instrument.

15. The method of claim 10, further comprising using an automated sampling system to prepare a sample for analysis using the capillary electrophoresis instrument.

16. The method of claim 10, further comprising adjusting an operating parameter of the absorption/desorption process, the concentrator, or both based on a signal from the capillary electrophoresis instrument.

17. The method of claim 16, wherein the operating parameter is a pH, a temperature, a pressure, a process time, a cycle time, a flow rate, or a stream split of the absorption/desorption process, the concentrator, or both.

18. A method of recovering lithium from a lithium source, comprising:
performing a plurality of sequential transformations, each transformation converting an input derived from the lithium source into an output containing lithium and a byproduct, the sequential transformations including an ion withdrawal process; and
monitoring a concentration of one or more components in one or more inputs, outputs, or byproducts using one or more capillary electrophoresis instruments.

19. The method of claim 18, wherein the plurality of sequential transformations further includes one or more of:
an impurity removal process;
a lithium concentration process;
a lithium conversion process.

20. The method of claim 18, including adjusting an operating parameter of one or more of the sequential transformations based on a signal from the one or more capillary electrophoresis instruments.
